(19) United States
(12) Patent Application Publication
(10) Pub. No.: US 2002/0146354 A1
(43) Pub. Date: Oct. 10, 2002

(54) Hydroform dual-wall catalytic converter

(76) Inventors: Hsin-Hong Huang, West Bloomfield, MI (US); Kenneth Mark Pickett, Monroe, MI (US); Gary Meyers, Farmington, MI (US)

Correspondence Address: BRINKS HOFER GILSON & LIONE, P.O. BOX 10395, CHICAGO, IL, 60610, US

(21) Appl. No.: 09/832,071

(22) Filed: Apr. 10, 2001

(51) Int. Cl. B01D 53/34; F01N 3/10

(52) U.S. Cl. 422/168; 422/177; 422/179

(57) ABSTRACT

The present invention discloses a dual-wall catalytic converter wherein the catalytic canister and the heat shield surrounding the catalytic canister are one integral piece. The method of forming the dual wall catalytic converter includes having two tubes of different diameters, placing one tube inside another and subjecting them to a hydroforming process. The tubes are then hydroformed into the converter geometry having an outer housing and an inner housing. In order to seal the outer housing to the inner housing the end portions of the outer housing are pressed against the surface of the inner housing. The catalytic substrate is added by cutting a portion of the inner housing and the outer housing such that the hollow interior of the inner housing is exposed. The catalytic substrate is then inserted inside and the end portions are welded back to obtain the dual-wall catalytic converter.

### TECHNICAL FIELD OF THE INVENTION

This invention generally relates to a catalytic converter to be installed in the exhaust system of an automobile. More specifically, the present invention relates a dual-wall catalytic converter and fabrication method wherein the canister of the catalytic substrate and the heat shield are formed in one process.

### BACKGROUND OF THE INVENTION

Internal combustion engines, which operate by the controlled combustion of hydrocarbon fuels, produce exhaust gases containing complete combustion products as well as un-burnt hydrocarbons (HC). Although the presence of pollutants in the exhaust gases of internal combustion engines has been recognized since 1901, the need to control internal combustion engine emissions in the U.S. came with the passage of the Clean Air Act in 1970. Engine manufacturers have explored a wide variety of technologies to meet the requirements of the Clean Air Act. The use of the catalysis has proven to be the most effective system to control the emission of noxious gas before they are released into the atmosphere.

Auto emission catalytic converters are typically located at the underbody of the automobile and are situated in the exhaust stream from the engine, close to the exhaust manifold. The catalytic converter is subject to an, extremely hostile environment due to the extremes of temperature as well as the structural and vibrational loads encountered under driving conditions. Therefore, technology has developed for catalytic substrate that can withstand such hostile conditions.

It is known in the art relating to vehicle engine exhaust catalytic converters for controlling exhaust emissions to provide a housing including an insulated cylindrical shell that house the catalytic substrate required for the necessary catalysis process. Typically these cylindrical shell or housing are made of two halves pressed from a sheet of stainless steel. The two halves are then welded along the longitudinal axis and the two halves generally define a catalytic chamber to insert the catalytic substrate inside the chamber.

Further, the typical catalytic converters also have end cone assemblies welded to this cylindrical shell for connecting the converter to associated exhaust pipes or components. As mentioned above, since extreme heat is generated from the cylindrical shell in order to protect the floor and the under body of a vehicle from heat, a heat shield surrounds the cylindrical shell. Typically the heat shield is separately welded into the outer body of the cylindrical shell having the catalyst substrate, some heat shields are installed on the vehicle/car body surface right above the catalytic converter. In some catalytic converters the end cones are a part of the housing but the housing is welded along the longitudinal axis.

Therefore, prior art processes of manufacturing the catalytic converter included multiple steps. Further, since the converters are welded along the longitudinal axis, there was always a danger of the converter tearing along the weld when in use.

Therefore, there is a need to manufacture the catalytic converter where the heat shield is formed as a part of the catalytic substrate housing.

### BRIEF SUMMARY OF THE INVENTION

Accordingly, this invention provides for an apparatus and a method of forming the dual-wall catalytic converter to be used in the exhaust system of a motor vehicle.

Briefly, the catalytic converter in accordance with the invention comprises an inner housing and an outer housing. The inner housing and the outer housing are formed of a central portion having a larger diameter and two end portions at each end of the central portion having diameters smaller than the central portion.

In order to fasten the outer housing to the inner housing an area of the end portion of the outer housing is deformed such that the diameter of the outer housing in that portion is reduced and the outer housing touches the walls of the inner housing.

Further, the catalytic converter in accordance with the invention includes a catalytic substrate inserted in the interior of the inner housing. In accordance with the teachings of the present invention, the inner housing serves as a canister for the catalytic converter and the outer housing as a heat shield for protecting the automotive underbody from exposure to high temperature.

The present invention also discloses a method for forming the dual-wall catalytic converter. Briefly stated, the method includes having two tubes of different diameters. Placing the tube with the smaller diameter inside the tube with a larger diameter and subjecting the tubes to a hydroforming process. By using the hydroforming technique the tubes are hydroformed into the converter geometry having an outer housing and an inner housing. In order to seal the outer housing to the inner housing the end portions of the outer housing are pressed against the surface of the inner housing. The catalytic substrate is added by separating a portion of the inner housing and the outer housing such that the hollow interior of the inner housing is exposed. The catalytic substrate is then inserted inside and the end portions are welded back to obtain the dual-wall catalytic converter in accordance with the teachings of the present invention.

### BRIEF DESCRIPTION OF THE DRAWINGS

Further features and advantages of the invention will become apparent from the following discussion and accompanying drawings, in which:

FIG. 1 is a cross-sectional view of the assembled dual-wall catalytic converter in accordance with the teachings of the preferred embodiment of the present invention;

FIG. 2 is a cross-sectional view of the inner tube and outer tube disposed inside a hydroforming die prior to the starting of the hydroforming process in accordance with the teachings of the preferred embodiment of the present invention;

FIG. 3 is a cross-sectional elevation view of the inner tube and the outer tube disposed inside a hydroforming die as illustrated in FIG. 1 expanded during the hydroforming process in accordance with the teachings of the preferred embodiment of the present invention;

FIG. 4 is a cross-sectional elevation view of the inner tube and the outer tube as illustrated in FIG. 1 wherein end portions of the outer tube are deformed by press dies in accordance with the teachings of the preferred embodiment of the present invention;

FIG. 5 is a cross-sectional elevation view of the inner tube and the outer tube as illustrated in FIG. 1 after having been removed from the hydroforming die in accordance with the teachings of the preferred embodiment of the present invention;

FIG. 6 is a cross-sectional elevation view of the inner tube and the outer tube as illustrated in FIG. 1 having a part of the inner tube and outer tube being separated and the catalytic substrate being inserted in accordance with the teachings of the preferred embodiment of the present invention; and

FIG. 7 is a cross-sectional view of the inner tube and the outer tube as illustrated in FIG. 6 having a part of the inner tube and outer tube being joined after the catalytic substrate is inserted in accordance with the teachings of the preferred embodiment of the present invention.

### DETAILED DESCRIPTION OF THE PREFERRED EMBODIMENT

The following description of the preferred embodiment is merely exemplary in nature, and is in no way intended to limit the invention or its application or uses.

Referring in particular to the drawings, a dual-wall catalytic converter to be installed in an exhaust system of a motor vehicle is generally illustrated by reference numeral 10. Although not shown in the drawings the catalytic converter 10 is typically installed in the under body of a vehicle and forms a part of the vehicle exhaust system. Alternatively, it may be installed in any other suitable place in the vehicle to typically convert the noxious emissions emitted from the engine.

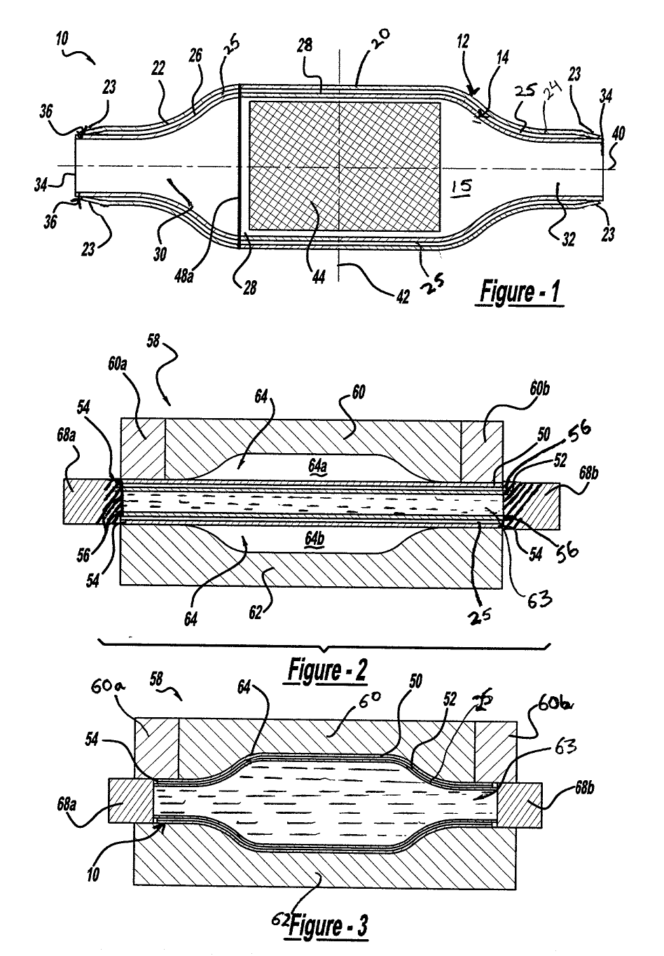

As shown in FIG. 1 the dual-wall catalytic converter 10 comprises an outer housing 12 and an inner housing 14. Although not shown in the drawings, typically one end of the inner housing 14 is connected a conduit for receiving exhaust gasses from the engine. The other end of the inner housing 14 is connected to a exhaust pipe that emits gases that have been converted by the catalytic converter 10.

As shown in FIG. 1, the outer housing 12 preferably is formed of a central portion 20 and two end portions 22 and 24 connected on either side of the central portion 20. The end portions 22 and 24 define an end portion 23. As seen in FIG. 1, central portion 20 defines a larger diameter than the diameters of at least one of the end portions 22 and 24. As seen in the drawings, the central portion 20 tapers from a relatively larger diameter to a smaller diameter where the end portions 22 and 24 are attached. Preferably, the end portions 22 and 24 have the same diameter. Alternatively, it is possible that the end portion 22 has a larger diameter than end portion 24. Preferably, central portion 20 has an oblong shape and the end portions 22 and 24 are cone-shaped. Further, it is preferred that the central portion 20 and the two end portions 22 and 24 are formed of one integral piece.

As shown in FIG. 1 the inner housing 14 of the dual-wall catalytic converter 10 has an identical shape and is sized to fit inside the outer housing 12. The inner housing 14 has a wall 26 and defines a hollow interior 15. Since the inner housing 14 has the same geometry as the outer housing 12, like the outer housing 12, the inner housing 14 also defines a central portion 28 and two end portions 30, 32 connected to the central portion 28. The end portions 30, 32 define an end portion 34 that extends longitudinally beyond the end portion 23 of the inner housing 12. Preferably, the central portion 28 has a larger diameter than the end portions 30 and 32. However, the central portions 28 and end portions 30, 32 of the inner housing 14 have a smaller diameter than the central portion 20 and the end portions 22, 24 of the outer housing 12. Preferably, the central portion 28 has a diameter larger than the diameters of the end portions 30, 32. In the preferred embodiment the central portion 28 of the inner housing 14 has an oblong shape and the end portions 30 and 32 are cone shaped.

As shown in FIG. 1 and will be explained later, during assembly the inner housing 14 is present inside the outer housing 12 to form the dual-wall catalytic converter 10. When the inner housing 14 is inserted inside the outer housing 12 the central portion 20 and the central portion 28 are co-axial with each other. Similarly, one end 22 of the outer housing 12 is co-axial with one end 30 of the inner housing 14 and the other end 24 of the of the outer housing 12 is co-axial with one end 32 of the inner housing 14. A gap 25 is defined between the inner housing 14 and the outer housing 12. As will be explained later, the air present in the gap 25 will act as a heat insulator and prevent the outer housing 12 from getting heated from the heat generated by the catalytic converter in the inner housing 14.

As shown in FIG. 1, when the inner housing 14 is inserted inside outer housing the end portion 34 of the inner housing extends beyond the end portion 23 of the outer housing 12. Preferably, as shown in FIG. 1, the end portion 23 of the outer housing 12 is deformed such that outer housing is in contact with the wall 26 of the inner housing 14. The area where the outer housing touches the wall 26 of the inner housing is represented by reference numeral 36. Therefore, at area 36, the outer housing defines a reduced diameter and the outer housing 12 is integrally connected to the inner housing 14.

Since the inner housing 14 and the outer housing 12 are subject to high heat, it is preferable that both the housings are made of heat-resistant material such as stainless steel. In the preferred embodiment the dual-wall catalytic converter 10 is symmetrical about a longitudinal axis 40 and a transverse axis 42. However, the dual-wall catalytic converter 10 may be unsymmetrical about the longitudinal axis 40 and the transverse axis 42.

As shown in FIG. 1, the dual-wall catalytic converter 10 in accordance with the teachings of the present invention also includes a catalytic substrate 44 inserted into the hollow interior 15 of the inner housing 14. As will be explained later, the catalytic substrate is present in the central portion 28 of the inner housing 14. The dual-wall catalytic converter 10 also defines a seam 48a wherein the end portions 22 and 30 of the outer housing 12 and the inner housing 14, respectively, are sealed to the central portion 20 and 28. Therefore, the inner housing 14 acts as a catalytic canister that is protected by the outer housing 12 that acts as a heat shield. The catalytic substrate 44 used in the present invention is commercially available from Dow Corning and is a ceramic composite brick with the suitable catalyst wash coated on the ceramic brick.

As shown in FIGS. 2 through 7, a method for assembling the dual-wall catalytic converter 10 in accordance with the teachings of the present invention is illustrated.

As shown in FIG. 2, a tube 50 used to form a vehicle component preferably a dual-wall catalytic converter 10. The tube 50 is conventional in the art and is preferably formed having a uniform wall thickness through the length thereof and defines ends 54, as shown in FIG. 2. In order to form the dual-wall catalytic converter 10 in accordance with the teachings of the present invention, a second tube 52 having a second diameter is placed inside the tube 50. Preferably, the diameter of tube 50 is greater than the diameter of the tube 52. Like tube 50, tube 52 defines a uniform wall thickness throughout the length thereof and has ends 56.

The tubes 50 and 52 are then disposed within a hydroforming die, indicated generally at 58. The hydroforming die 58 is conventional in the art and is based on the well-known technology. Typically the hydroforming die 58, comprises an upper die section 60 and a lower die section 62. Although in the preferred embodiment and the drawings illustrate a linearly extending tubes 50 and 52 disposed in the die 58, alternately, tubes that have been pre-bent, or that has otherwise been pre-formed in any other known manner can also be used. The upper die section 60 is modular and comprises end sections 60a and 60b. These end sections 60a and 60b can be removed as will be illustrated later and substituted with other die section to form the desired shape.

Referring in particular to FIG. 2 the die sections 60 and 62 define cavity portions 64a and 64b therein that cooperate to form a hydroforming die cavity 64 when the die sections 60 and 62 are moved into engagement with one another as shown in FIG. 2. The inner surface of the die cavity 64 of the hydroforming die 58 preferably corresponds to the desired cross sectional shape of the tubes 50 and 52 after the hydroforming operation has been performed. Thus, the inner surface of the die cavity 64 of the hydroforming die 58 may be formed such that the desired shape for the tubes 50 and 52 may be obtained. The cavity portions 64a and 64b are preferably formed relatively in the center of the tubes 50 and 52. As will be explained later the perimeter of the tubes 50 and 52 will be increased within these cavity portions 64A and 64B of the hydroforming die 58 during the hydroforming operation.

The end portions 56 and 54 of the inner tube 52 and outer tube 50 are adapted to be engaged by respective end feed cylinders 68a and 68b of a hydroforming die 58. The end feed cylinders 68a and 68b are conventional in the art and are adapted to seal against the respective end portions 56 and 54 and to conduct pressurized fluid represented by reference numeral 63 into the interior of the tubes 50 and 52 in a manner described further below.

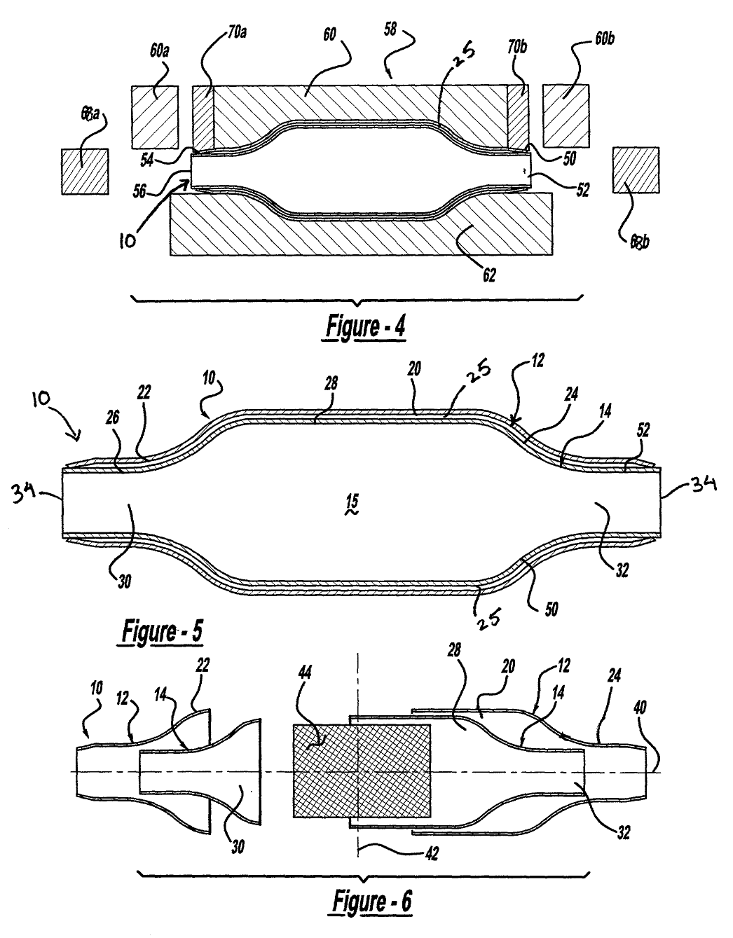

As shown in FIG. 3, the hydroforming operation is, of itself, conventional in the art and uses pressurized fluid to deform and expand the tubes 50 and 52 within the die cavity 64 of the hydroforming die 58. To accomplish this, the end portions 56 and 52 of the tubes are initially engaged by the end feed cylinders 68a and 68b. The tubes 50 and 52 are filled with a pressurized fluid, typically a relatively incompressible liquid such as water indicated generally as 63. The pressure of the fluid is increased to a magnitude where the tubes 50 and 52 deformed outwardly within the die cavity 64. The amount of pressure applied would be such that the perimeter of the outer tube will deform more than the perimeter of the inner tube, such that the gap 25 is maintained between the tubes. As a result, the tube 50 is deformed into the shape as illustrated in FIG. 3, wherein the tubes 50 and 52 correspond to the shape of the die cavity 64 of the hydroforming die 58. In order to obtain the dual-wall catalytic converter 10 in accordance with the teachings of the present invention and as described above, the following additional steps are performed.

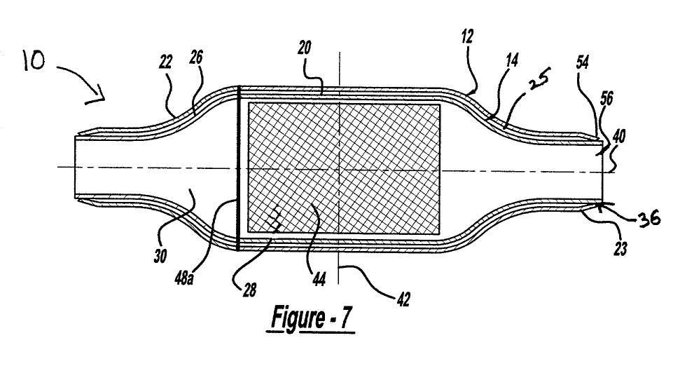

As shown in FIG. 4, the end portions 60a and 60b of the upper die section 60 are removed with the help of an actuator (not shown) and substituted with two press dies 70a and 70b. The press dies 70b and 70b then exert pressure against the ends 54 of the outer tube 50 such that the diameter of the outer tube 50 is reduced at the ends 54. Preferably the ends 54 of the outer tube are deformed such that the deformed ends 54 touches the walls of the inner tube 52. As will be explained later, the ends 54 of the outer tube 50 will be joined with the inner tube 52 such that the tubes are joined at the ends 54. Following the hydroforming operation, the tubes 50 and 52 are removed from the hydroforming die 58 as shown in FIG. 5. The tubes are now deformed to have the shape of the dual-wall catalytic converter 10. The hydroforming deformation of the outer tube 50 results in the formation of the outer housing 12. As described above, the outer housing 12 has a central portion 20 and two end portions 22, 24 connected on either side of the central portion 20. Similarly, the hydroforming deformation of the inner tube 52 results in the formation of the inner housing 14. The inner housing 14, defines a wall 26, a central portion 28, end portions 30, 32 connected on either side of central portion 28 and a hollow interior 15. A gap 25 is defined between the inner housing 14 and the outer housing 12.

In order to insert a catalytic substrate 44 into the inner housing 14, the process shown in FIGS. 6 and 7 is followed. Preferably, the end portion 22 of the outer housing 14 and the end portion 30 of the inner housing 14 are separated from the central portions 20 and 28 of the outer housing 12 and inner housing 14 respectively. Preferably, the end portions 22 and 30 are separated along the transverse axis 42. By separating the end portion 30 of the inner housing 14 from the central portion 28 the hollow interior 15 of the inner housing 14 is exposed. Although in the preferred embodiment laser cutting techniques are used, it is possible to use any well-known cutting techniques that do not substantially generate heat while cutting the end portions 22 and 30 such as heat welding etc.

A typical catalytic substrate 44 commercially available from Dow Corning, Inc. where the suitable catalyst is coated on top of the ceramic material is inserted into the exposed interior 15 of the central portion 28 of the inner housing 14. After the catalytic substrate 44 has been housed inside the central portion 28, the end portion 30 of the inner housing 14 is first sealed back to the central portion 28. After this step, the end portion 22 of the outer housing 12 is sealed back to the central portion 20 of the outer housing (as shown in FIG. 7). Therefore, a seam 48A connecting the end portion 22 and 30 to the central portions 22 and 28 respectively, is formed along the transverse axis 42 of the catalytic converter 10. Alternatively, the process of resealing the end portions 22 and 30 to the central portions 22 and 28 may be performed in a single step. In the preferred embodiment laser welding is used, although it is possible to use any well-known welding techniques.

As discussed above, in order to integrate the inner housing 14 and the outer housing 12 as one piece, the ends 54 of the outer housing 12 is joined to the walls 26 of the inner housing 14. Preferably, the inner housing 14 and the outer housing 12 are joined using the well-known laser welding techniques. Although, it is possible to use other well known welding technique such as heat welding etc.

The present method and apparatus provides for a uniform structure wherein the catalytic canister (inner housing 14) and the heat shield (outer housing 12) are one integral piece. This particular method eliminates any requirement for a separate process of providing a heat shield around a catalytic canister. Further, the hydroforming process eliminates any need for welding a catalytic canister 10 along a longitudinal axis 40 of a catalytic canister 14 thereby allowing the catalytic converter 10 to withstand more heat and pressure.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

What is claimed is:

1. A dual-wall catalytic converter to be installed in a motor vehicle comprising:
a first tube defining a hollow interior having a first diameter;
a second tube defining a hollow interior having a second diameter wherein the first diameter is larger than the second diameter such that the second tube is inserted inside the hollow interior of the first tube;
wherein the first tube and second tube are expanded to a pre-determined shape such that the first tube when expanded defines an outer housing and the second tube when expanded defines an inner housing inside the outer housing;
a gap defined between the inner housing and the outer housing;
wherein the pre-determined shape of the outer housing and inner housing comprises a central part, a first part and a second part, wherein the central part tapers from a relatively larger diameter to a smaller diameter such that the first part and the second part are connected to the central part along the transverse axis of the catalytic converter;
wherein the inner housing is integrally connected to the outer housing by deforming an end portion of the first part and second part of the outer housing such that the end portion is in contact with the first part and the and second part of the inner housing; and
a catalytic substrate inserted within the inner housing.

2. The dual-wall catalytic converter of claim 1 wherein the first tube and the second tube are expanded using a hydroforming process.

3. The dual-wall catalytic converter of claim 1 the first part of the inner housing and the outer housing is separated from the central part along the transverse axis to insert the catalytic substrate into the central part of the inner housing.

4. The dual-wall catalytic converter of claim 1 wherein the central part of the inner housing and the central part of the outer housing are co axial with each other.

5. The dual-wall catalytic converter of claim 1 wherein the diameters of the first part and the second part of the outer housing and the inner housing are equal.

6. The dual-wall catalytic converter of claim 1 wherein the first part and the second part of the inner housing extend longitudinally beyond the first part and the second part of the outer housing.

7. The dual-wall catalytic converter of claim 1 wherein the central part of the outer housing and the inner housing is cylindrical.

8. The dual-wall catalytic converter of claim 1 wherein the central part of the outer housing and the inner housing is non-cylindrical.

9. The dual-wall catalytic converter of claim 1 wherein the first part and second part of the outer housing and inner housing are cone shaped.

10. The dual-wall catalytic converter of claim 1 wherein the outer housing and inner housing are made of stainless steel.

11. A dual-wall catalytic converter to be installed in a motor vehicle comprising:
an outer housing having a first part, a second part, and a central part between the first part and the second part, wherein at least the first part or the second part is connected to the central part along the transverse axis of the dual-wall catalytic converter;
an inner housing inside the outer housing, the inner housing having a first part, a second part, and a central part between the first part and the second part, wherein at least the first part or the second part is connected to the central part along the transverse axis of the dual-wall catalytic converter;
such that the first part, the second part, and the central part of the outer housing are coaxial with the first part, the second part, and the central part of the inner housing;
wherein the inner housing is integrally connected to the outer housing by deforming an end portion of the first part and second part of the outer housing such that the end portion is in contact with the first part and the and second part of the inner housing; and
a catalytic substrate in central part of the inner housing.

12. The dual-wall catalytic converter of claim 1, the first part of the inner housing and the first part of the outer housing are separated from the central part of the outer housing and inner housing respectively, along the transverse axis to insert the catalytic substrate into the central part of the inner housing.

13. The dual-wall catalytic converter of claim 11 wherein the diameter of the central part of the outer housing is larger than the diameter of the first part and the second part of the outer housing.

14. The dual-wall catalytic converter of claim 11 wherein the diameter of the first part and the second part of the outer housing are equal.

15. The dual-wall catalytic converter of claim 11 wherein the diameter of the central part of the inner housing is larger than the diameter of the first part and the second part of the inner housing.

16. The dual-wall catalytic converter of claim 11 wherein the diameter of the first part and the second part of the inner housing are equal.

17. The dual-wall catalytic converter of claim 11 wherein the first part and the second part of the inner housing extend longitudinally beyond the first part and the second part of the outer housing.

18. The dual-wall catalytic converter of claim 11 wherein the central part of the outer housing is cylindrical.

19. The dual-wall catalytic converter of claim 11 wherein the central part of the outer housing is non-cylindrical.

20. The dual-wall catalytic converter of claim 11 wherein the central part of the inner housing is cylindrical.

21. The dual-wall catalytic converter of claim 11 wherein the central part of the inner housing is non-cylindrical.

22. The dual-wall catalytic converter of claim 11 wherein the first part and second part of the outer housing are cone shaped.

23. The dual-wall catalytic converter of claim 11 wherein the first part and second part of the inner housing are cone shaped.

24. The dual-wall catalytic converter of claim 11 wherein the outer housing and inner housing are made of stainless steel.

25. A method of forming a dual-wall catalytic converter the method comprising the steps of:
having a first tube of first cross-section;
having a second tube of second cross-section wherein the second cross-section is smaller than the first cross-section;
placing the second tube inside the first tube;
hydroforming the first tube and the second tube into a predetermined shape such that the first tube forms an outer housing and the second tube forms an inner housing wherein the inner housing and the outer housing comprise, a first part, a second part and a central part between the first part and the second part, such that the central part tapers from a relatively larger diameter to a smaller diameter;
deforming an end portion of the first part and second part of the outer housing such that the end portion is in contact with the inner housing;
separating the first part of the outer housing from the central part such that the first part is cut along a transverse axis;
separating the first part of the inner housing from the central part such that the first part is cut along a transverse axis; and
inserting a catalytic substrate in the central part of the inner housing.

26. The method of claim 25 further comprising the steps of:
joining the separated first part to the central part of the inner housing along the transverse axis of the inner housing to seal the catalytic substrate in the central part of the inner housing;
joining the separated first part to the central part of the outer housing along the transverse axis of the outer housing; and
joining the deformed ends portions of the outer housing to the inner housing such that the inner housing and the outer housing are one integral piece.
